(19) United States
(12) Patent Application Publication
(10) Pub. No.: US 2024/0126301 A1
(43) Pub. Date: Apr. 18, 2024

(54) UNMANNED VEHICLE MANAGEMENT SYSTEM AND UNMANNED VEHICLE MANAGEMENT METHOD

(71) Applicant: Komatsu Ltd., Tokyo (JP)

(72) Inventors: Takashi Yamamoto, Tokyo (JP); Takashi Hiranaka, Tokyo (JP); Kenta Osagawa, Tokyo (JP)

(73) Assignees: Komatsu Ltd., Tokyo (JP); Komatsu Ltd., Tokyo (JP)

(21) Appl. No.: 18/278,644

(22) PCT Filed: Dec. 28, 2021
(86) PCT No.: PCT/JP2021/048915

§ 371 Date: Aug. 24, 2023

(30) Foreign Application Priority Data
Mar. 16, 2021 (JP) 2021-042710

(51) Int. Cl. G05D 1/646; G05D 1/248; G05D 1/69; G05D 107/70; G05D 109/10

(52) U.S. Cl. CPC G05D 1/646; G05D 1/248; G05D 1/69; G05D 2107/73; G05D 2109/10

(57) ABSTRACT

An unmanned vehicle management system includes: a traveling area definition unit that defines a traveling area on a traveling path of a work site; and a determination unit that determines whether or not an unmanned vehicle can enter the traveling area on the basis of a vehicle width indicating the width of the unmanned vehicle and a track width indicating the width of the traveling area.

### FIELD

The present disclosure relates to an unmanned vehicle management system and an unmanned vehicle management method.

### BACKGROUND

As disclosed in Patent Literature 1, unmanned vehicles travel in a wide work site such as a mine.

### CITATION LIST

### Patent Literature

Patent Literature 1: JP 2008-210378 A

### SUMMARY

### Technical Problem

A traveling path is developed at a work site. An unmanned vehicle travels on the traveling path. For example, in a case where a traveling path having an unnecessarily wide road is developed, it is difficult to suppress the cost required for developing the traveling path.

An object of the present disclosure is to suppress cost required for developing a traveling path and to enable the unmanned vehicle to appropriately travel on the traveling path.

### Solution to Problem

According to an aspect of the present invention, an unmanned vehicle management system comprises: a traveling area definition unit that defines a traveling area on a traveling path of a work site; and a determination unit that determines whether or not an unmanned vehicle can enter the traveling area on a basis of a vehicle width indicating a width of the unmanned vehicle and a track width indicating a width of the traveling area.

### Advantageous Effects of Invention

According to the present disclosure, the cost required for developing a traveling path is suppressed, and an unmanned vehicle can appropriately travel on the traveling path.

### BRIEF DESCRIPTION OF DRAWINGS

FIG. 1 is a schematic diagram illustrating an unmanned vehicle management system of according to an embodiment.

FIG. 2 is a perspective view illustrating an unmanned haul vehicle according to the embodiment.

FIG. 3 is a perspective view illustrating an unmanned sprinkler vehicle according to the embodiment.

FIG. 4 is a schematic diagram illustrating a work site according to the embodiment.

FIG. 5 is a functional block diagram illustrating an unmanned vehicle management system according to the embodiment.

FIG. 6 is a diagram for explaining a first traveling area according to the embodiment.

FIG. 7 is a diagram for explaining a second traveling area according to the embodiment.

FIG. 8 is a flowchart illustrating a method of defining a traveling area according to the embodiment.

FIG. 9 is a schematic diagram illustrating a traveling course defined in a traveling path according to the embodiment.

FIG. 10 is a schematic diagram illustrating a first traveling area and a second traveling area defined in the traveling path according to the embodiment.

FIG. 11 is a flowchart illustrating a method of determining whether or not an unmanned vehicle can pass according to the embodiment.

### DESCRIPTION OF EMBODIMENTS

Hereinafter, embodiments of the present disclosure will be described with reference to the drawings; however, the present disclosure is not limited thereto. Components of the embodiments described below can be combined as appropriate. Moreover, some of the components may not be used.

[Overview of Management System]

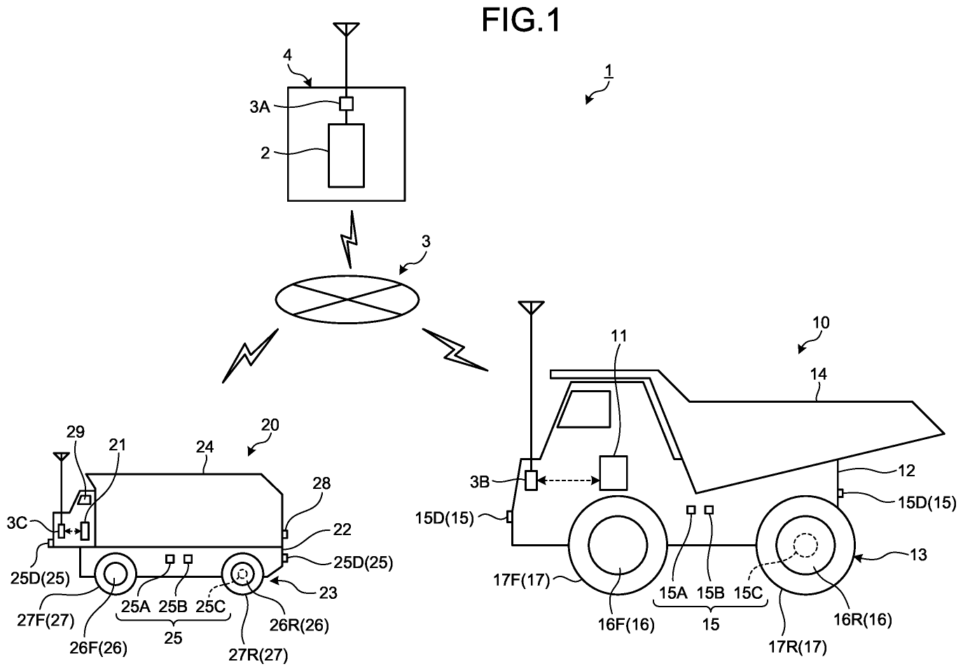

FIG. 1 is a schematic diagram illustrating an unmanned vehicle management system 1 according to an embodiment. The management system 1 manages unmanned vehicles operating at the work site. An unmanned vehicle refers to a work vehicle that operates in an unmanned manner without depending on a driving operation by a driver. In the embodiment, the unmanned vehicles operating at the work site include a first unmanned vehicle 10 and a second unmanned vehicle 20. The dimensions of the outer shape of the first unmanned vehicle 10 is different from the dimensions of the outer shape of the second unmanned vehicle 20. The dimensions of the outer shape of the second unmanned vehicle 20 are smaller than the dimensions of the outer shape of the first unmanned vehicle 10.

In the embodiment, the first unmanned vehicle 10 is an unmanned haul vehicle. The second unmanned vehicle is an unmanned sprinkler vehicle. In the following description, the first unmanned vehicle 10 is referred to as the unmanned haul vehicle 10 as appropriate, and the second unmanned vehicle 20 is referred to as the unmanned sprinkler vehicle 20 as appropriate.

The unmanned haul vehicle 10 travels in an unmanned manner at the work site to transport a load. An example of the unmanned haul vehicle 10 is an unmanned dump truck. A load transported by the unmanned haul vehicle 10 is exemplified by an excavated object excavated at the work site.

The unmanned sprinkler vehicle 20 travels in the work site in an unmanned manner and sprinkles water. An example of the unmanned sprinkler vehicle 20 is an unmanned sprinkler truck. The unmanned sprinkler vehicle 20 sprinkles water to suppress diffusion of dust or sand at the work site.

The management system 1 includes a management device 2 and a communication system 3. The management device 2 is installed in a control facility 4 at the work site. There is an administrator in the control facility 4.

The unmanned haul vehicle 10 includes a control device 11. The unmanned sprinkler vehicle 20 includes a control device 21. The management device 2, the control device 11, and the control device 21 wirelessly communicate with each other via the communication system 3. A wireless communication device 3A is connected to the management device 2. A wireless communication device 3B is connected to the control device 11. A wireless communication device 3C is connected to the control device 21. The communication system 3 includes the wireless communication device 3A, the wireless communication device 3B, and the wireless communication device 3C.

[Unmanned Haul Vehicle]

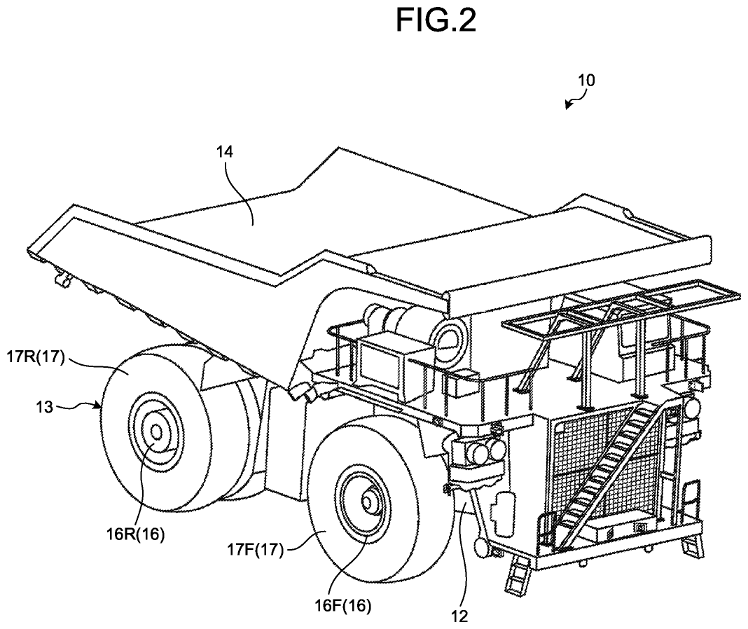

FIG. 2 is a perspective view illustrating the unmanned haul vehicle 10 according to the embodiment. As illustrated in FIGS. 1 and 2, the unmanned haul vehicle 10 includes the wireless communication device 3B, the control device 11, a vehicle body 12, a traveling device 13, a dump body 14, and a sensor system 15.

The vehicle body 12 includes a vehicle body frame. The vehicle body 12 is supported by the traveling device 13. The vehicle body 12 supports the dump body 14.

The traveling device 13 generates a driving force for causing the unmanned haul vehicle 10 to travel. The traveling device 13 generate a braking force for decelerating or stopping the unmanned haul vehicle 10. The traveling device 13 generates a steering force for causing the unmanned haul vehicle 10 to turn. The traveling device 13 causes the unmanned haul vehicle 10 to travel forward or backward. The traveling device 13 includes wheels 16. A tire 17 is mounted on a wheel 16. The wheels 16 include front wheels 16F and rear wheels 16R. The tires 17 include front tires 17F mounted on the front wheels 16F and rear tires 17R mounted on the rear wheels 16R. With the wheels 16 rotating in a state where the tires 17 are in contact with the road surface of the work site, the unmanned haul vehicle 10 travels through the work site.

The dump body 14 is a member on which a load is loaded. At least a part of the dump body 14 is disposed above the vehicle body 12.

The sensor system 15 includes a position sensor 15A, an azimuth sensor 15B, a speed sensor 15C, and an obstacle sensor 15D. The position sensor 15A detects the position of the unmanned haul vehicle 10. The position of the unmanned haul vehicle 10 is detected using a global navigation satellite system (GNSS). The position sensor 15A includes a GNSS receiver and detects the position of the unmanned haul vehicle 10 in the global coordinate system. The azimuth sensor 15B detects the azimuth of the unmanned haul vehicle 10. The azimuth sensor 15B is exemplified by a gyro sensor. The speed sensor 15C detects the travel speed of the unmanned haul vehicle 10. The speed sensor 15C is exemplified by a pulse sensor that detects the rotation of a wheel 16. The obstacle sensor 15D detects an obstacle around the unmanned haul vehicle 10. The obstacle sensor 15D detects an obstacle in a non-contact manner. Examples of the obstacle sensor 15D include a laser sensor (light detection and ranging (LIDAR)) and a radar sensor (radio detection and ranging (RADAR)).

[Unmanned Sprinkler Vehicle]

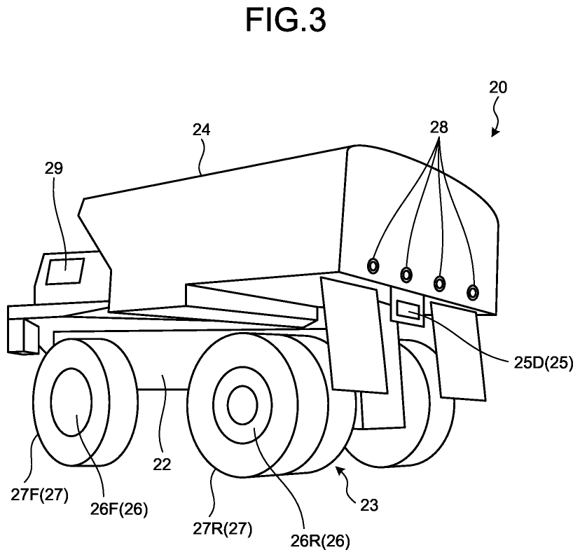

FIG. 3 is a perspective view illustrating the unmanned sprinkler vehicle 20 according to the embodiment. As illustrated in FIGS. 1 and 3, the unmanned sprinkler vehicle 20 includes the wireless communication device 3C, the control device 21, a vehicle body 22, a traveling device 23, a tank 24, a sensor system 25, and water sprays 28.

The vehicle body 22 includes a vehicle body frame. The vehicle body 22 is supported by the traveling device 23. The vehicle body 22 supports the tank 24.

In the embodiment, a cab 29 is provided to the vehicle body 22. The cab 29 is provided at a front portion of the vehicle body 22. A driver can board the cab 29 and perform a driving operation of the unmanned sprinkler vehicle 20. For example, when performing maintenance or inspection of the unmanned sprinkler vehicle 20, the driver performs a driving operation of the unmanned sprinkler vehicle 20. In the embodiment, the unmanned sprinkler vehicle 20 operates in an unmanned manner at least when sprinkling water at the work site. Note that the cab 29 may not be included in the unmanned sprinkler vehicle 20.

The traveling device 23 generates a driving force for causing the unmanned sprinkler vehicle 20 to travel. The traveling device 23 generate a braking force for decelerating or stopping the unmanned sprinkler vehicle 20. The traveling device 23 generates a steering force for causing the unmanned sprinkler vehicle 20 to turn. The traveling device 23 causes the unmanned sprinkler vehicle 20 to travel forward or backward. The traveling device 23 includes wheels 26. A tire 27 is mounted on a wheel 26. The wheels 26 include front wheels 26F and rear wheels 26R. The front wheels 26F are steering wheels, and the rear wheels 26R are driving wheels. Note that both the front wheels 26F and the rear wheels 26R may be steering wheels. Both the front wheels 26F and the rear wheels 26R may be driving wheels. The front wheels 26F may be driving wheels, and the rear wheels 26R may be steering wheels. The tires 27 include front tires 27F mounted on the front wheels 26F and rear tires 27R mounted on the rear wheels 26R. With the wheels 26 rotating in a state where the tires 27 are in contact with the road surface of the work site, the unmanned sprinkler vehicle 20 travels through the work site.

The tank 24 is a member for storing water for sprinkling. At least a part of the tank 24 is disposed above the vehicle body 22.

The sensor system 25 includes a position sensor 25A, an azimuth sensor 25B, a speed sensor 25C, and an obstacle sensor 25D. The position sensor 25A detects the position of the unmanned sprinkler vehicle 20. The position of the unmanned sprinkler vehicle 20 is detected using a global navigation satellite system (GNSS). The position sensor 25A includes a GNSS receiver and detects the position of the unmanned sprinkler vehicle 20 in the global coordinate system. The azimuth sensor 25B detects the azimuth of the unmanned sprinkler vehicle 20. The azimuth sensor 25B is exemplified by a gyro sensor. The speed sensor 25C detects the travel speed of the unmanned sprinkler vehicle 20. The speed sensor 25C is exemplified by a pulse sensor that detects the rotation of a wheel 26. The obstacle sensor 25D detects an obstacle around the unmanned sprinkler vehicle 20. The obstacle sensor 25D detects an obstacle in a non-contact manner. Examples of the obstacle sensor 25D include a laser sensor (light detection and ranging (LIDAR)) and a radar sensor (radio detection and ranging (RADAR)).

The water sprays 28 spray water in the tank 24. The water sprays 28 are arranged at a rear portion of the tank 24. The water sprays 28 sprinkle water behind the unmanned sprinkler vehicle 20. In the embodiment, a plurality of water sprays 28 is included. The plurality of water sprays 28 is arranged at intervals in the vehicle width direction of the unmanned sprinkler vehicle 20 at the rear portion of the tank 24. The vehicle width direction refers to a direction parallel to the rotation axis of the wheels 26 when the unmanned sprinkler vehicle 20 is traveling straight.

[Work Site]

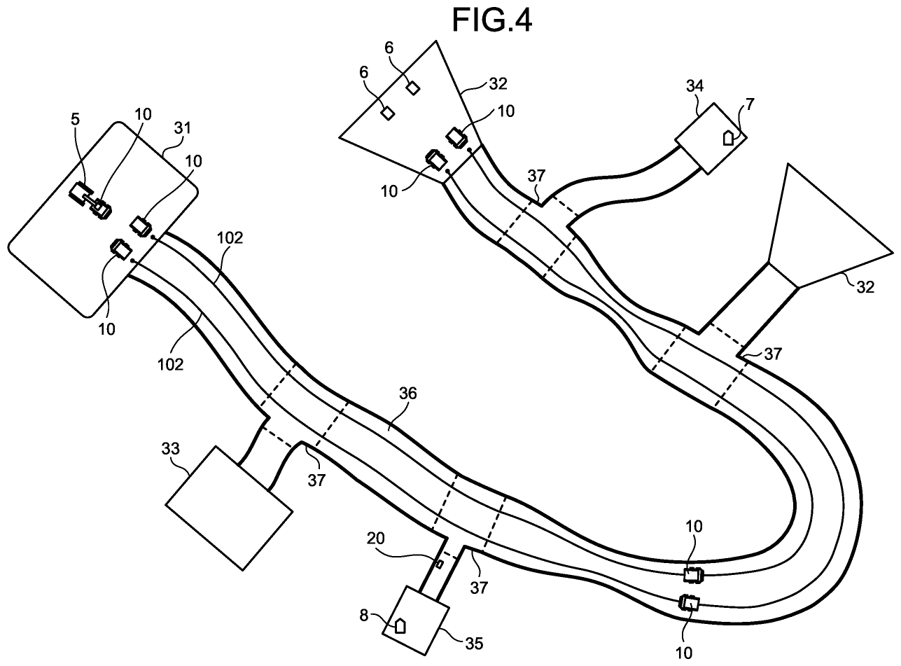

FIG. 4 is a schematic diagram illustrating the work site according to the embodiment. Examples of the work site include a mine or a quarry. The mine refers to a place or a business site where minerals are mined. The quarry refers to a place or a business site where stones are mined. At the work site, unmanned haul vehicles 10 and the unmanned sprinkler vehicle 20 each operate.

In the embodiment, the work site is a mine. Examples of the mine include a metal mine for mining metals, a non-metal mine for mining limestone, and a coal mine for mining coal.

At the work site, a loading area 31, a soil discharging area 32, a parking area 33, a refueling station 34, a water supply station 35, traveling paths 36, and intersections 37 are provided.

The loading area 31 refers to an area where loading work for loading a load on an unmanned haul vehicle is performed. In the loading area 31, a loader 5 operates. The loader 5 is exemplified by an excavator.

The soil discharging area 32 refers to an area where discharging work for discharging a load from an unmanned haul vehicle 10 is performed. Crushers 6 are provided in the soil discharging area 32.

The parking area 33 refers to an area where at least one of the unmanned haul vehicles 10 or the unmanned sprinkler vehicle 20 is parked.

The refueling station 34 refers to an area where at least one of the unmanned haul vehicles 10 or the unmanned sprinkler vehicle 20 is supplied with fuel. A fuel feeder 7 that supplies fuel is provided in the refueling station 34.

The water supply station 35 refers to an area where the unmanned sprinkler vehicle 20 is supplied with water. At the water supply station 35, water for sprinkling is supplied to the tank 24. A water supplier 8 for supplying water to the tank 24 is provided at the water supply station 35.

A traveling path 36 refers to an area where an unmanned vehicle travels toward at least one of the loading area 31, the soil discharging area 32, the parking area 33, the refueling station 34, or the water supply station 35. The traveling paths 36 are provided in such a manner as to connect at least the loading area 31 and the soil discharging area 32. In the embodiment, a traveling path 36 is connected to each of the loading area 31, the soil discharging area 32, the parking area 33, the refueling station 34, and the water supply station 35.

An intersection 37 refers to an area where a plurality of traveling paths 36 intersect or an area where one traveling path 36 branches into a plurality of traveling paths 36.

[Management System]

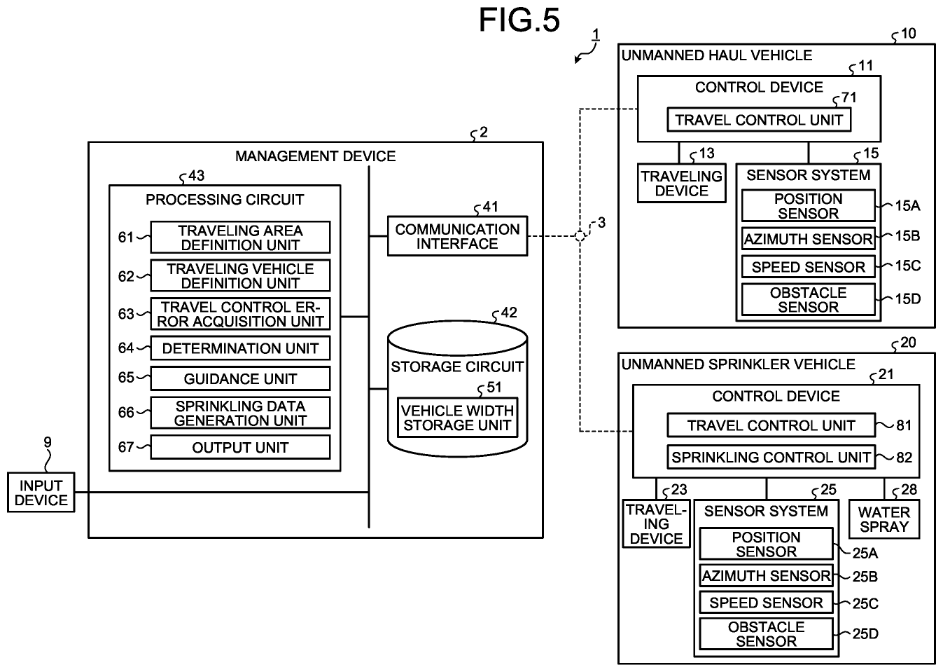

FIG. 5 is a functional block diagram illustrating the unmanned vehicle management system 1 according to the embodiment. The management system 1 includes the management device 2, the communication system 3, the control device 11, and the control device 21.

The management device 2 includes a computer system. The management device 2 is connected to an input device 9. The management device 2 includes a communication interface 41, a storage circuit 42, and a processing circuit 43.

The input device 9 is connected to the processing circuit 43. The input device 9 is operated by the administrator of the control facility 4. The input device 9 generates input data on the basis of the operation by the administrator. The input data generated by the input device 9 is input to the processing circuit 43. Examples of the input device 9 include a touch panel, a computer keyboard, a mouse, and an operation button. Note that the input device 9 may be a non-contact type input device including an optical sensor or may be a voice input device.

The communication interface 41 is connected to the processing circuit 43. The communication interface 41 controls communication between the management device 2 and at least one of the control device 11 or the control device 21. The communication interface 41 communicates with at least one of the control device 11 or the control device 21 via the communication system 3.

The storage circuit 42 is connected to the processing circuit 43. The storage circuit 42 stores data. Examples of the storage circuit 42 include a nonvolatile memory and a volatile memory. Example of the nonvolatile memory include a read only memory (ROM) or a storage. Examples of the storage include a hard disk drive (HDD) and a solid state drive (SSD). An example of the volatile memory is a random access memory (RAM).

The processing circuit 43 performs arithmetic processing and output processing of a control command. An example of the processing circuit 43 is a processor. Examples of the processor include a central processing unit (CPU) and a micro processing unit (MPU). A computer program is stored in the storage circuit 42. The processing circuit 43 exerts a predetermined function by acquiring and executing the computer program from the storage circuit 42.

The storage circuit 42 includes a vehicle width storage unit 51.

The vehicle width storage unit 51 stores vehicle widths indicating the widths of unmanned vehicles. The vehicle widths of the unmanned vehicles include a first vehicle width WV1 indicating the width of the unmanned haul vehicle 10 and a second vehicle width WV2 indicating the width of the unmanned sprinkler vehicle 20. The vehicle width storage unit 51 stores each of the first vehicle width WV1 indicating the width of the unmanned haul vehicle and the second vehicle width WV2 indicating the width of the unmanned sprinkler vehicle 20. The first vehicle width WV1 is a dimension of an outer shape of the unmanned haul vehicle 10 in a direction parallel to the rotation axis of the wheels 16 in the unmanned haul vehicle 10 in a straight traveling state. The second vehicle width WV2 refers to a dimension of an outer shape of the unmanned sprinkler vehicle 20 in a direction parallel to the rotation axis of the wheels 26 in the unmanned sprinkler vehicle 20 in a straight traveling state. The first vehicle width WV1 is known data derived from specifications of the unmanned haul vehicle 10. The second vehicle width WV2 is known data derived from specifications of the unmanned sprinkler vehicle 20. Each of the first vehicle width WV1 and the second vehicle width WV2 is input to the storage circuit 42 via the input device 9. The vehicle width storage unit 51 stores each of the first vehicle width WV1 and the second vehicle width WV2 input from the input device 9. In the embodiment, the dimension of the outer shape of the unmanned sprinkler vehicle 20 is smaller than the dimension of the outer shape of the unmanned haul vehicle 10. The second vehicle width WV2 of the unmanned sprinkler vehicle is narrower than the first vehicle width WV1 of the unmanned haul vehicle 10.

The processing circuit 43 includes a traveling area definition unit 61, a traveling vehicle definition unit 62, a travel control error acquisition unit 63, a determination unit 64, a guidance unit 65, a sprinkling data generation unit 66, and an output unit 67.

The traveling area definition unit 61 defines a traveling area in a traveling path 36 at the work site. The traveling area refers to an area where an unmanned vehicle is permitted to travel along a target traveling track (traveling course). In the embodiment, traveling areas defined by the traveling area definition unit 61 includes a first traveling area 103 having a first track width WL1 and a second traveling area 203 having a second track width WL2 narrower than the first track width WL1.

The traveling vehicle definition unit 62 defines an unmanned vehicle to be caused to travel in a traveling area of the work site. In the embodiment, unmanned vehicles defined by the traveling vehicle definition unit 62 include unmanned haul vehicles 10 having the first vehicle width WV1 and the unmanned sprinkler vehicle 20 having the second vehicle width WV2 narrower than the first vehicle width WV1.

The travel control error acquisition unit 63 acquires a travel control error (positional deviation amount Δ) in the vehicle width direction of an unmanned vehicle traveling at a target travel speed (first travel speed). The travel control error (positional deviation amount Δ) of the unmanned vehicle in the vehicle width direction refers to a deviation amount in the vehicle width direction between a target position and an actual position of the unmanned vehicle traveling along a target traveling track (traveling course). The travel control error acquisition unit 63 acquires a travel control error (positional deviation amount Δ) corresponding to a target travel speed of each of the unmanned haul vehicles 10 and the unmanned sprinkler vehicle 20. The travel control errors (positional deviation amounts Δ) are stored in advance in the storage circuit 42. The travel control errors (positional deviation amounts Δ) are stored in the storage circuit 42 in advance on the basis of travel test results, for example. The travel control error (positional deviation amount Δ) increases as the travel speed of an unmanned vehicle increases and decreases as the travel speed of the unmanned vehicle decreases.

The determination unit 64 determines whether or not an unmanned vehicle can enter a traveling area on the basis of a vehicle width indicating the width of the unmanned vehicle and a track width indicating the width of the traveling area. In a case where it is determined that the vehicle width of the unmanned vehicle is narrower than the track width of the traveling area, the determination unit 64 determines that the unmanned vehicle can enter the traveling area.

Moreover, in a case where it is determined that the unmanned vehicle traveling at a target travel speed does not deviate from the traveling area on the basis of the positional deviation amount Δ acquired by the travel control error acquisition unit 63, the determination unit 64 determines that the unmanned vehicle can enter the traveling area. Furthermore, in a case where it is determined that the unmanned vehicle traveling at the target travel speed does not deviate from the traveling area even if the unmanned vehicle deviates from the traveling area when the unmanned vehicle travels at a travel speed (second travel speed) lower than the target travel speed, the determination unit 64 determines that the unmanned vehicle can enter the traveling area.

The guidance unit 65 guides the unmanned haul vehicles 10 so that the unmanned haul vehicles 10 enter the first traveling area 103 and does not enter the second traveling area 203. The guidance unit 65 guides the unmanned sprinkler vehicle 20 so that the unmanned sprinkler vehicle 20 enters each of the first traveling area 103 and the second traveling area 203. The guidance unit 65 outputs a guidance command for guiding the unmanned haul vehicles 10 so that the unmanned haul vehicles 10 enter the first traveling area 103 and does not enter the second traveling area 203. The guidance unit 65 outputs a guidance command for guiding the unmanned sprinkler vehicle so that the unmanned sprinkler vehicle 20 enters each of the first traveling area 103 and the second traveling area 203.

The sprinkling data generation unit 66 generates sprinkling data for controlling the water sprays 28. The sprinkling data includes at least one of execution and stop of sprinkling from the water sprays 28, a sprinkling position where the water sprays 28 sprinkles water at the work site, or the amount of water sprinkled per unit time from the water sprays 28. The sprinkling position at which the water sprays 28 sprinkle water includes a sprinkling area indicating an area in a traveling path 36 (work site) to be sprinkled from the water sprays 28. Incidentally, in a case where a plurality of water sprays 28 is provided, the sprinkling data includes the number of water sprays 28 that sprinkle water. In addition, in a case where the water sprays 28 are installed at a plurality of positions of the unmanned sprinkler vehicle 20, the sprinkling data includes installation positions of water sprays 28 that sprinkle water. The sprinkling data generation unit 66 may generate the sprinkling data on the basis of input data from the input device 9.

The output unit 67 transmits course data defined by the traveling area definition unit 61 to the unmanned vehicles. The output unit 67 transmits the course data from the communication interface 41 to each of the control devices 11 of the unmanned haul vehicles 10 and the control device 21 of the unmanned sprinkler vehicle 20. The output unit 67 also transmits the sprinkling data generated by the sprinkling data generation unit 66 to the unmanned sprinkler vehicle 20. The output unit 67 transmits the sprinkling data from the communication interface 41 to the control device 21 of the unmanned sprinkler vehicle 20.

The control device 11 includes a computer system. Similarly to the management device 2, the control device 11 includes a communication interface, a storage circuit, and a processing circuit. The control device 11 includes a travel control unit 71 that controls the traveling device 13. The travel control unit 71 controls the traveling device 13 on the basis of the course data transmitted from the management device 2.

The control device 21 includes a computer system. Similarly to the management device 2, the control device 21 includes a communication interface, a storage circuit, and a processing circuit. The control device 21 includes a travel control unit 81 that controls the traveling device 23 and a sprinkling control unit 82 that controls the water sprays 28. The travel control unit 81 controls the traveling device 23 on the basis of the course data transmitted from the management device 2. The sprinkling control unit 82 controls the water sprays 28 on the basis of the sprinkling data transmitted from the management device 2.

[Traveling Area]

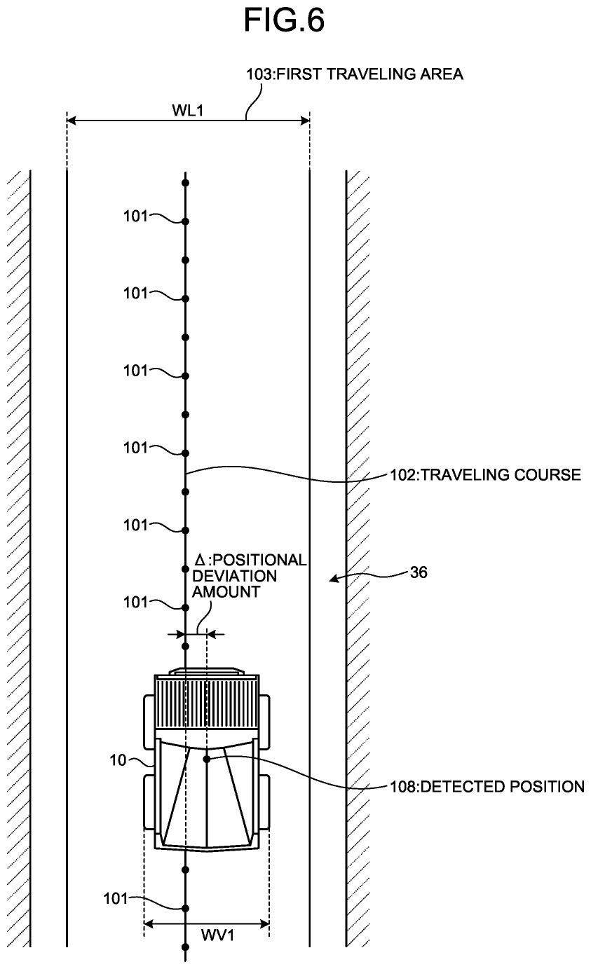

FIG. 6 is a diagram for explaining the first traveling area 103 according to the embodiment.

The traveling area definition unit 61 defines the first traveling area 103 on a traveling path 36. The first traveling area 103 is defined on the basis of the course data that defines traveling conditions of the unmanned vehicles (the unmanned haul vehicles 10 and the unmanned sprinkler vehicle 20). The traveling area definition unit 61 defines each of the course data and the first traveling area 103.

In the embodiment, the course data is shared by the unmanned haul vehicles 10 and the unmanned sprinkler vehicle 20.

The course data is defined by the traveling area definition unit 61. The course data includes course points 101, a traveling course 102, a target position of an unmanned vehicle, a target azimuth of the unmanned vehicle, and a target travel speed of the unmanned vehicle.

A plurality of course points 101 is set on the traveling path 36. A course point 101 defines a target position of the unmanned vehicle. A target travel speed and a target azimuth of the unmanned vehicle are set at each of the plurality of course points 101. The plurality of course points 101 are set at intervals. An interval between course points 101 is set, for example, within a range of 1 [m] to 5 [m]. The intervals between the course points 101 may be uniform or non-uniform.

The traveling course 102 refers to a virtual line indicating a target traveling track of the unmanned vehicle. The traveling course 102 is defined by a track passing through the plurality of course points 101. The unmanned vehicle travels on the traveling path 36 along the traveling course 102.

A target position of the unmanned vehicle refers to a target position of the unmanned vehicle when passing through a course point 101. Note that the target position of the unmanned vehicle may be defined in a local coordinate system of the unmanned vehicle or in the global coordinate system.

A target azimuth of the unmanned vehicle refers to a target azimuth of the unmanned vehicle when passing through a course point 101.

A target travel speed of the unmanned vehicle refers to a target travel speed of the unmanned vehicle when passing through a course point 101. The target travel speed of the unmanned vehicle includes an upper limit speed (speed limit) indicating an upper limit value of the travel speed of the unmanned vehicle. The unmanned vehicle travels at a travel speed not exceeding the upper limit speed at the work site.

The travel control unit 71 of the unmanned haul vehicle 10 controls the traveling device 13 on the basis of the course data and detection data of the sensor system 15. The travel control unit 71 controls the traveling device 13 in such a manner that the unmanned haul vehicle 10 travels along the traveling course 102 on the basis of detection data of the position sensor 15A and detection data of the azimuth sensor 15B. That is, the travel control unit 71 controls the traveling device 13 in such a manner that a positional deviation amount Δ indicating a deviation between a target position of the unmanned haul vehicle 10 set at a course point 101 and a detected position 108 of the unmanned haul vehicle 10 detected by the position sensor 15A when passing through the course point 101 is small. In addition, the travel control unit 71 controls the traveling device 13 in such a manner that a deviation between a target azimuth of the unmanned haul vehicle 10 set at the course point 101 and a detected azimuth of the unmanned haul vehicle 10 detected by the azimuth sensor 15B when passing through the course point 101 is small. Furthermore, the travel control unit 71 controls the traveling device 13 in such a manner that the unmanned haul vehicle 10 travels at a target travel speed on the basis of detection data of the speed sensor 15C. That is, the travel control unit 71 controls the traveling device 13 in such a manner that a deviation between the target travel speed of the unmanned haul vehicle 10 set at the course point 101 and a detected travel speed of the unmanned haul vehicle 10 detected by the speed sensor 15C when passing through the course point 101 is small.

As described above, the target travel speed of the unmanned haul vehicle 10 includes the upper limit speed of the unmanned haul vehicle 10. The travel control unit 71 controls the traveling device 13 in such a manner that the unmanned haul vehicle 10 travels at a travel speed not exceeding the upper limit speed on the basis of the detection data of the speed sensor 15C. That is, the travel control unit 71 controls the traveling device 13 in such a manner that the detected travel speed of the unmanned haul vehicle 10 detected by the speed sensor 15C when passing through the course point 101 does not exceed the upper limit speed of the unmanned haul vehicle 10 set to the course point 101.

The travel control unit 81 of the unmanned sprinkler vehicle 20 controls the traveling device 23 on the basis of the course data and detection data of the sensor system 25. The travel control unit 81 controls the traveling device 23 in such a manner that the unmanned sprinkler vehicle 20 travels along the traveling course 102 on the basis of detection data of the position sensor 25A and detection data of the azimuth sensor 25B. That is, the travel control unit 81 controls the traveling device 23 in such a manner that a positional deviation amount Δ indicating a deviation between a target position of the unmanned sprinkler vehicle 20 set at a course point 101 and a detected position 208 of the unmanned sprinkler vehicle 20 detected by the position sensor 25A when passing through the course point 101 is small. In addition, the travel control unit 81 controls the traveling device 23 in such a manner that a deviation between a target azimuth of the unmanned sprinkler vehicle 20 set at the course point 101 and a detected azimuth of the unmanned sprinkler vehicle 20 detected by the azimuth sensor 25B when passing through the course point 101 is small. Furthermore, the travel control unit 81 controls the traveling device 23 in such a manner that the unmanned sprinkler vehicle 20 travels at a target travel speed on the basis of detection data of the speed sensor 25C. That is, the travel control unit 81 controls the traveling device 23 in such a manner that a deviation between the target travel speed of the unmanned sprinkler vehicle 20 set at the course point 101 and a detected travel speed of the unmanned sprinkler vehicle 20 detected by the speed sensor 25C when passing through the course point 101 is small.

As described above, the target travel speed of the unmanned sprinkler vehicle 20 includes the upper limit speed of the unmanned sprinkler vehicle 20. The travel control unit 81 controls the traveling device 23 in such a manner that the unmanned sprinkler vehicle 20 travels at a travel speed not exceeding the upper limit speed on the basis of the detection data of the speed sensor 25C. That is, the travel control unit 81 controls the traveling device 23 in such a manner that the detected travel speed of the unmanned sprinkler vehicle 20 detected by the speed sensor 25C when passing through the course point 101 does not exceed the upper limit speed of the unmanned sprinkler vehicle 20 set to the course point 101.

The traveling area definition unit 61 defines the first traveling area 103 on the basis of the traveling course 102 and the first vehicle width WV1 of the unmanned haul vehicle 10. The traveling area definition unit 61 defines the first traveling area 103 in such a manner that the traveling course 102 passes through the center of the first traveling area 103 in the vehicle width direction of the unmanned haul vehicle 10. The traveling area definition unit 61 defines the first traveling area 103 in such a manner that the first track width WL1 of the first traveling area 103 is wider than the first vehicle width WV1 of the unmanned haul vehicle 10.

In the embodiment, the traveling area definition unit 61 defines the first track width WL1 of the first traveling area 103 on the basis of the positional deviation amount Δ of the unmanned haul vehicle 10 traveling at the upper limit speed. That is, the traveling area definition unit 61 defines the first track width WL1 of the first traveling area 103 so that the unmanned haul vehicle 10 traveling at the upper limit speed along the traveling course 102 does not deviate from the first traveling area 103 even in a case of deviation from the traveling course 102. In the embodiment, the first track width WL1 is the sum of the first vehicle width WV1 of the unmanned haul vehicle 10 and the travel control error of the unmanned haul vehicle 10. The travel control unit 71 controls the traveling device 13 on the basis of the target position of the unmanned haul vehicle 10 set at the course point 101 and the detected position 108 of the unmanned haul vehicle detected by the position sensor 15A when the unmanned haul vehicle 10 passes through the course point 101 so that the unmanned haul vehicle 10 does not deviate from the first traveling area 103.

The traveling area definition unit 61 defines the first traveling area 103 in such a manner that the first track width WL1 of the first traveling area 103 is narrower than the width of the traveling path 36.

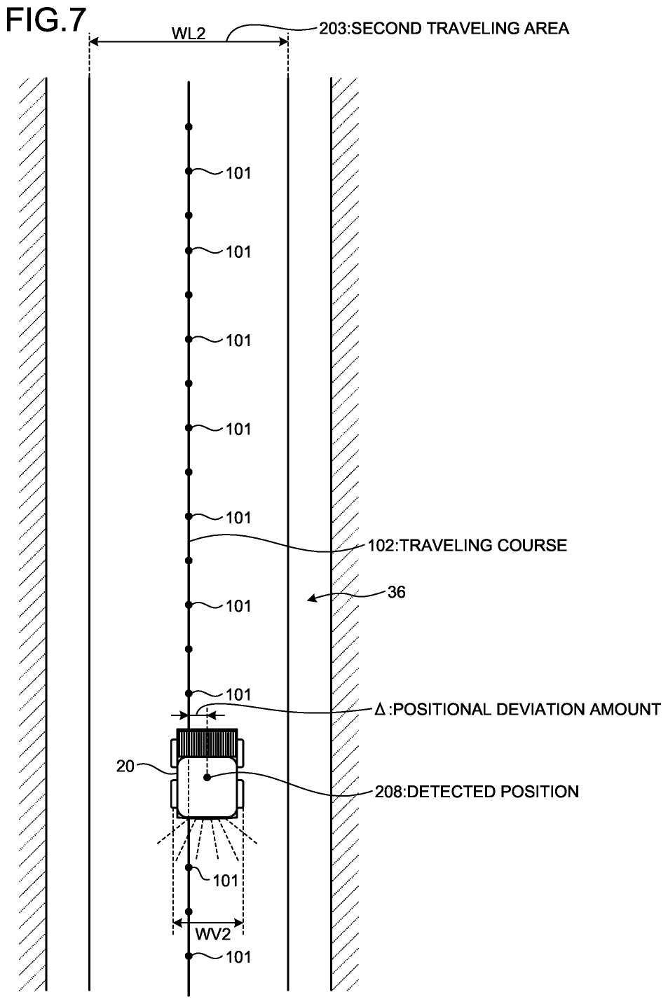

FIG. 7 is a diagram for explaining the second traveling area 203 according to the embodiment.

The traveling area definition unit 61 defines the second traveling area 203 on a traveling path 36. The second traveling area 203 is defined on the basis of the course data.

The traveling area definition unit 61 defines the second traveling area 203 on the basis of the traveling course 102 and the second vehicle width WV2 of the unmanned sprinkler vehicle 20. The traveling area definition unit 61 defines the second traveling area 203 in such a manner that the traveling course 102 passes through the center of the second traveling area 203 in the vehicle width direction of the unmanned sprinkler vehicle 20. The traveling area definition unit 61 defines the second traveling area 203 in such a manner that the second track width WL2 of the second traveling area 203 is wider than the second vehicle width WV2 of the unmanned sprinkler vehicle 20.

In the embodiment, the traveling area definition unit 61 defines the second track width WL2 of the second traveling area 203 on the basis of the positional deviation amount Δ of the unmanned sprinkler vehicle 20 traveling at the upper limit speed. That is, the traveling area definition unit 61 defines the second track width WL2 of the second traveling area 203 so that the unmanned sprinkler vehicle 20 traveling at the upper limit speed along the traveling course 102 does not deviate from the second traveling area 203 even in a case of deviation from the traveling course 102. In the embodiment, the second track width WL2 is the sum of the second vehicle width WV2 of the unmanned sprinkler vehicle 20 and the travel control error of the unmanned sprinkler vehicle 20. The travel control unit 81 controls the traveling device 13 on the basis of the target position of the unmanned sprinkler vehicle 20 set at the course point 101 and the detected position 208 of the unmanned sprinkler vehicle 20 detected by the position sensor 25A when the unmanned sprinkler vehicle 20 passes through the course point 101 so that the unmanned sprinkler vehicle 20 does not deviate from the second traveling area 203.

The traveling area definition unit 61 defines the second traveling area 203 in such a manner that the second track width WL2 of the second traveling area 203 is narrower than the width of the traveling path 36.

[Method for Defining Traveling Area]

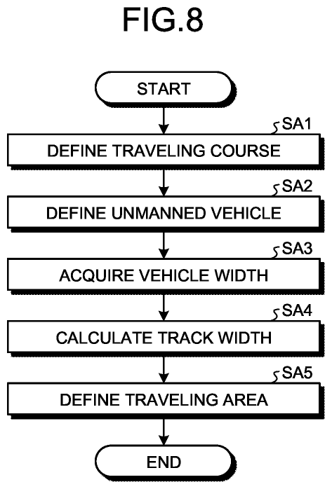

FIG. 8 is a flowchart illustrating a method of defining a traveling area according to the embodiment.

The traveling area definition unit 61 generates course data of an unmanned vehicle. The traveling area definition unit 61 defines a traveling course 102 on a traveling path 36 at the work site (Step SA1).

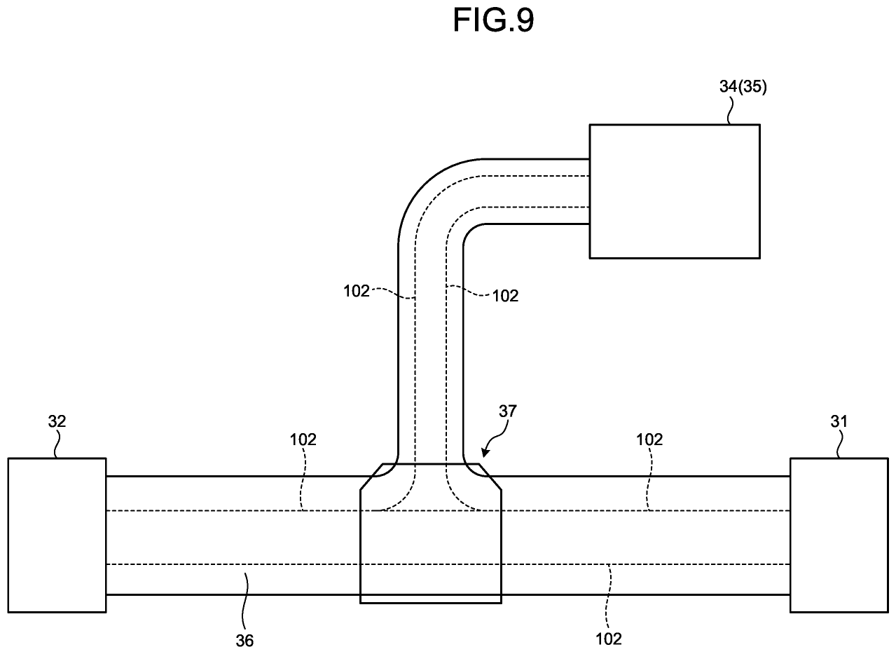

FIG. 9 is a schematic diagram illustrating traveling courses 102 defined in a traveling path 36 according to the embodiment. In the example illustrated in FIG. 9, the traveling courses 102 are defined in such a manner as to connect a loading area 31, a soil discharging area 32, and a refueling station 34 or a water supply station 35.

The traveling vehicle definition unit 62 defines an unmanned vehicle to be caused to travel in the traveling area. In the embodiment, the traveling vehicle definition unit 62 defines the unmanned haul vehicle 10 and the unmanned sprinkler vehicle 20 as unmanned vehicles to be caused to travel in the traveling area (Step SA2).

The traveling area definition unit 61 acquires the vehicle widths of the unmanned vehicles from the vehicle width storage unit 51. In the embodiment, the traveling area definition unit 61 acquires the first vehicle width WV1 of the unmanned haul vehicle 10 and the second vehicle width WV2 of the unmanned sprinkler vehicle 20 (Step SA3).

The traveling area definition unit 61 calculates the first track width WL1 of the first traveling area 103 where the unmanned haul vehicle 10 and the unmanned sprinkler vehicle 20 can travel on the basis of the first vehicle width WV1. The traveling area definition unit 61 also calculates the second track width WL2 of the second traveling area 203 where the unmanned sprinkler vehicle 20 can travel on the basis of the second vehicle width WV2 (Step SA4).

The first track width WL1 in which the unmanned haul vehicle 10 can travel is wider than the first vehicle width WV1. The second track width WL2 in which the unmanned sprinkler vehicle 20 can travel is wider than the second vehicle width WV2.

The traveling area definition unit 61 defines the first traveling area 103 in such a manner as to have the first track width WL1 calculated in Step SA4. The traveling area definition unit 61 defines the second traveling area 203 so as to have the second track width WL2 calculated in Step SA4 (Step SA5).

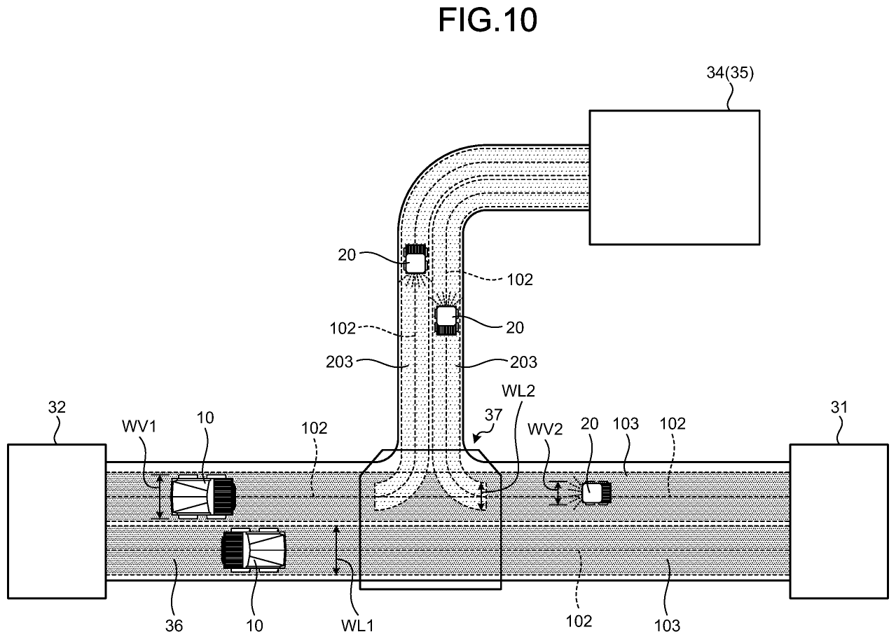

FIG. 10 is a schematic diagram illustrating the first traveling areas 103 and the second traveling areas 203 defined on the traveling path 36 according to the embodiment. As illustrated in FIG. 10, each of the first traveling areas 103 and the second traveling areas 203 is defined in such a manner as to include a traveling course 102. In the example illustrated in FIG. 10, the first traveling areas 103 are defined on the traveling path 36 connecting the loading area 31 and the soil discharging area 32. The second traveling areas 203 are defined on the traveling path 36 connecting an intersection 37 and the refueling station 34 or the water supply station 35.

[Method of Determining Whether or Not Unmanned Vehicle Can Pass]

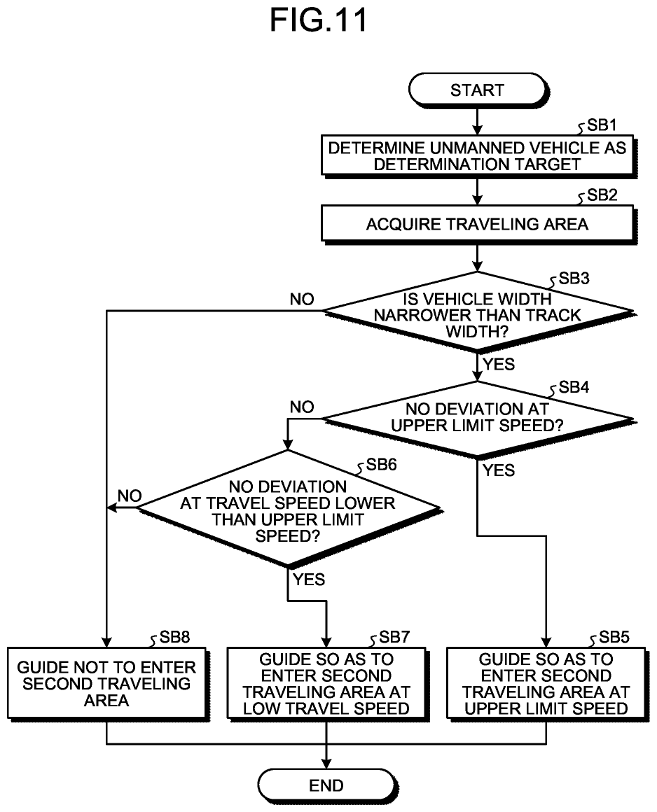

FIG. 11 is a flowchart illustrating a method of determining whether or not an unmanned vehicle can pass according to the embodiment.

The determination unit 64 determines whether or not a predetermined unmanned vehicle can enter a traveling area (103 or 203) defined by the traveling area definition unit 61. That is, the determination unit 64 determines whether or not the predetermined unmanned vehicle can travel in a traveling area defined by the traveling area definition unit 61. The determination unit 64 determines an unmanned vehicle as a target of the determination from among a plurality of unmanned vehicles defined by the traveling vehicle definition unit 62 (Step SB1).

As an example, it is based on the premise that an unmanned haul vehicle 10 that travels from the soil discharging area 32 to the refueling station 34 via the intersection 37 and then travels from the refueling station 34 toward the loading area 31 via the intersection 37 is the target of the determination.

The determination unit 64 acquires the traveling areas (103 and 203) defined by the traveling area definition unit 61 as described by referring to FIG. 10 (Step SB2).

The determination unit 64 determines whether or not the first vehicle width WV1 of the unmanned haul vehicle 10 is narrower than each of the first track width WL1 of the first traveling areas 103 and the second track width WL2 of the second traveling areas 203 (Step SB3).

If it is determined in Step SB3 that the first vehicle width WV1 is narrower than each of the first track width WL1 and the second track width WL2 (Step SB3: Yes), the determination unit 64 determines whether or not the unmanned haul vehicle 10 deviates from each of the first traveling areas 103 and the second traveling areas 203 even if the unmanned haul vehicle 10 travels at the upper limit speed (first travel speed) in each of the first traveling areas 103 and the second traveling areas 203 (Step SB4).

In Step SB4, if it is determined that the unmanned haul vehicle 10 traveling at the upper limit speed can travel without deviating from each of the first traveling areas 103 and the second traveling areas 203 (Step SB4: Yes), the guidance unit 65 outputs a guidance command to the unmanned haul vehicle 10 so as to enter the second traveling areas 203 at the upper limit speed. That is, the guidance unit 65 outputs the guidance command to the unmanned haul vehicle 10 so as to travel from the soil discharging area 32 toward the refueling station 34 via the intersection 37 and then to travel from the refueling station 34 toward the loading area 31 via the intersection 37. The guidance unit 65 outputs a guidance command to the unmanned haul vehicle 10 so as to travel at the upper limit speed in each of the first traveling areas 103 and the second traveling areas 203 (Step SB5).

In Step SB4, if it is determined that the unmanned haul vehicle 10 traveling at the upper limit speed does not deviate from the first traveling area 103 but deviates from the second traveling area 203 (Step SB4: No), the determination unit 64 determines whether or not the unmanned haul vehicle 10 deviates from the second traveling area 203 if the travel speed is lower than the upper limit speed (second travel speed) (Step SB6).

In Step SB6, if it is determined that the unmanned haul vehicle 10 does not deviate from the second traveling area 203 if the travel speed is lower than the upper limit speed (Step SB6: Yes), the guidance unit 65 outputs a guidance command to the unmanned haul vehicle 10 so as to enter the second traveling area 203 at a travel speed lower than the upper limit speed. That is, the guidance unit 65 outputs the guidance command to the unmanned haul vehicle 10 so as to travel from the soil discharging area 32 toward the refueling station 34 via the intersection 37 and then to travel from the refueling station 34 toward the loading area 31 via the intersection 37. The guidance unit 65 outputs a guidance command to the unmanned haul vehicle 10 so as to travel at the upper limit speed in the first traveling areas 103 and to travel at a travel speed lower than the upper limit speed in the second traveling areas 203 between the intersection 37 and the refueling station 34 (Step SB7).

If it is determined in Step SB6 that the unmanned haul vehicle 10 deviates from the second traveling areas 203 even at a travel speed lower than the upper limit speed (Step SB6: No), or if it is determined in Step SB3 that the first vehicle width WV1 is wider than the second track width WL2 (Step SB3: No), the guidance unit 65 outputs a guidance command to the unmanned haul vehicle 10 so as not to enter the second traveling areas 203 (Step SB8).

That is, the guidance unit 65 outputs the guidance command to the unmanned haul vehicle 10 so as not to head to the refueling station 34. The guidance unit 65 outputs the guidance command to the unmanned haul vehicle so as to travel from the soil discharging area 32 toward the loading area 31.

The method of determining whether or not the unmanned haul vehicle 10 can pass has been described above by referring to FIG. 11. A similar method also applies to the unmanned sprinkler vehicle 20. In the embodiment, the unmanned sprinkler vehicle 20 can enter each of the first traveling areas 103 and the second traveling areas 203. That is, the second vehicle width WV2 is narrower than the first track width WL1 and is narrower than the second track width WL2. The guidance unit 65 can output a guidance command for guiding the unmanned sprinkler vehicle 20 so that the unmanned sprinkler vehicle 20 enters each of the first traveling areas 103 and the second traveling areas 203.

[Effects]

As described above, according to the embodiment, the traveling areas (103 and 203) are defined in the traveling paths 36 at the work site. It is determined whether or not an unmanned vehicle can enter a traveling area on the basis of the vehicle width of the unmanned vehicle and the track width of the traveling area. Therefore, development of a traveling path 36 having an unnecessarily wide width is suppressed. Therefore, the cost required for development of the traveling paths 36 is reduced. The first traveling areas 103 where both the unmanned haul vehicle 10 and the unmanned sprinkler vehicle 20 travel are defined depending on the first vehicle width WV1 of the unmanned haul vehicle 10. Therefore, each of the unmanned haul vehicle 10 and the unmanned sprinkler vehicle 20 can smoothly travel in the first traveling areas 103. On the basis of the first vehicle width WV1 of the unmanned haul vehicle 10 and the second vehicle width WV2 of the unmanned sprinkler vehicle 20, the first traveling areas 103 where both the unmanned haul vehicle 10 and the unmanned sprinkler vehicle 20 travel are defined, and the second traveling areas 203 where the unmanned haul vehicle 10 does not travel but the unmanned sprinkler vehicle 20 travels are defined. With the first traveling areas 103 and the second traveling areas 203 each defined, traveling conditions of each of the unmanned haul vehicle 10 and the unmanned sprinkler vehicle 20 are determined appropriately on the basis of the first traveling areas 103 and the second traveling areas 203. Therefore, each of the unmanned haul vehicle 10 and the unmanned sprinkler vehicle 20 can appropriately travel in the work site.

When determining that a vehicle width is narrower than a track width, the determination unit 64 determines that the unmanned vehicle can enter the traveling area. As a result, the unmanned vehicle can travel without deviating from the traveling area.

Even in a case where the vehicle width is narrower than the track width, there is a possibility of deviation from the traveling area when the unmanned vehicle travels in the traveling area at a high speed. In a case where it is determined that the unmanned vehicle traveling at the upper limit speed (first travel speed) does not deviate from the traveling area, the determination unit 64 determines that the unmanned vehicle can enter the traveling area. As a result, the unmanned vehicle can travel at a high speed without deviating from the traveling area.

In a case where it is determined that the unmanned vehicle traveling at the upper limit (first travel speed) does not deviate from the traveling area even if the unmanned vehicle deviates from the traveling area when the unmanned vehicle travels at a travel speed (second travel speed) lower than the upper limit, the determination unit 64 determines that the unmanned vehicle can enter the traveling area. As a result, the unmanned vehicle can travel without deviating from the traveling area.

### OTHER EMBODIMENTS

In the above-described embodiment, at least some of the functions of the control device 11 and the control device 21 may be included in the management device 2, and at least some of the functions of the management device 2 may be included in one or both of the control device 11 and the control device 21. For example, in the above-described embodiment, the control device 11 may have the function of the traveling area definition unit 61, the function of the traveling vehicle definition unit 62, the function of the travel control error acquisition unit 63, the function of the determination unit 64, and the function of the guidance unit 65. The control device 21 may have the function of the traveling area definition unit 61, the function of the traveling vehicle definition unit 62, the function of the travel control error acquisition unit 63, the function of the determination unit 64, the function of the guidance unit 65, and the function of the sprinkling data generation unit 66.

In the above embodiment, each of the traveling area definition unit 61, the traveling vehicle definition unit 62, the travel control error acquisition unit 63, the determination unit 64, the guidance unit 65, the sprinkling data generation unit 66, and the output unit 67 may be configured by separate pieces of hardware.

In the above embodiment, the first unmanned vehicle 10 is the unmanned haul vehicle, and the second unmanned vehicle 20 is the unmanned sprinkler vehicle. Both the first unmanned vehicle 10 and the second unmanned vehicle 20 may be unmanned haul vehicles. The first unmanned vehicle 10 may be an unmanned haul vehicle having the first vehicle width, and the second unmanned vehicle 20 may be an unmanned haul vehicle having the second vehicle width.

### REFERENCE SIGNS LIST

1 MANAGEMENT SYSTEM
2 MANAGEMENT DEVICE
3 COMMUNICATION SYSTEM
3A WIRELESS COMMUNICATION DEVICE
3B WIRELESS COMMUNICATION DEVICE
3C WIRELESS COMMUNICATION DEVICE
4 CONTROL FACILITY
5 LOADER
6 CRUSHER
7 FUEL FEEDER
8 WATER SUPPLIER
9 INPUT DEVICE
10 UNMANNED HAUL VEHICLE (FIRST UNMANNED VEHICLE)
11 CONTROL DEVICE
12 VEHICLE BODY
13 TRAVELING DEVICE
14 DUMP BODY
15 SENSOR SYSTEM
15A POSITION SENSOR
15B AZIMUTH SENSOR
15C SPEED SENSOR
15D OBSTACLE SENSOR
16 WHEEL
16F FRONT WHEEL
16R REAR WHEEL
17 TIRE
17F FRONT TIRE
17R REAR TIRE
20 UNMANNED SPRINKLER VEHICLE (SECOND UNMANNED VEHICLE)
21 CONTROL DEVICE
22 VEHICLE BODY
23 TRAVELING DEVICE
24 TANK
25 SENSOR SYSTEM
25A POSITION SENSOR
25B AZIMUTH SENSOR
25C SPEED SENSOR
25D OBSTACLE SENSOR
26 WHEEL
26F FRONT WHEEL
26R REAR WHEEL
27 TIRE
27F FRONT TIRE
27R REAR TIRE
28 WATER SPRAY
29 CAB
31 LOADING AREA
32 SOIL DISCHARGING AREA
33 PARKING AREA
34 REFUELING STATION
35 WATER SUPPLY STATION
36 TRAVELING PATH
37 INTERSECTION
41 COMMUNICATION INTERFACE
42 STORAGE CIRCUIT
43 PROCESSING CIRCUIT
51 VEHICLE WIDTH STORAGE UNIT
61 TRAVELING AREA DEFINITION UNIT
62 TRAVELING VEHICLE DEFINITION UNIT
63 TRAVEL CONTROL ERROR ACQUISITION UNIT
64 DETERMINATION UNIT
65 GUIDANCE UNIT
66 SPRINKLING DATA GENERATION UNIT
67 OUTPUT UNIT
71 TRAVEL CONTROL UNIT
81 TRAVEL CONTROL UNIT
82 SPRINKLING CONTROL UNIT
101 COURSE POINT
102 TRAVELING COURSE
103 FIRST TRAVELING AREA
108 DETECTION POSITION
203 SECOND TRAVELING AREA
208 DETECTION POSITION
WL1 FIRST TRACK WIDTH
WL2 SECOND TRACK WIDTH
WV1 FIRST VEHICLE WIDTH
WV2 SECOND VEHICLE WIDTH

1. An unmanned vehicle management system comprising:
a traveling area definition unit that defines a traveling area on a traveling path of a work site; and
a determination unit that determines whether or not an unmanned vehicle can enter the traveling area on a basis of a vehicle width indicating a width of the unmanned vehicle and a track width indicating a width of the traveling area.

2. The unmanned vehicle management system according to claim 1,
wherein, in a case where it is determined that the vehicle width is narrower than the track width, the determination unit determines that the unmanned vehicle can enter the traveling area.

3. The unmanned vehicle management system according to claim 1, further comprising:
a travel control error acquisition unit that acquires a positional deviation amount in a vehicle width direction of the unmanned vehicle traveling at a first travel speed,
wherein the determination unit determines that the unmanned vehicle can enter the traveling area in a case where it is determined that the unmanned vehicle traveling at the first travel speed does not deviate from the traveling area.

4. The unmanned vehicle management system according to claim 3,
wherein, in a case where it is determined that even if the unmanned vehicle traveling at the first travel speed deviates from the traveling area, the unmanned vehicle traveling does not deviate from the traveling area when traveling at a second travel speed lower than the first travel speed, the determination unit determines that the unmanned vehicle can enter the traveling area.

5. The unmanned vehicle management system according to claim 1,
wherein the traveling area defined by the traveling area definition unit comprises a first traveling area having a first track width and a second traveling area having a second track width narrower than the first track width, and
the unmanned vehicle comprises a first unmanned vehicle having a first vehicle width and a second unmanned vehicle having a second vehicle width narrower than the first vehicle width,
the unmanned vehicle management system further comprising:
a guidance unit that guides the first unmanned vehicle such that the first unmanned vehicle enters the first traveling area and does not enter the second traveling area and guides the second unmanned vehicle such that the second unmanned vehicle enters each of the first traveling area and the second traveling area.

6. The unmanned vehicle management system according to claim 5,
wherein the first unmanned vehicle is an unmanned haul vehicle, and
the second unmanned vehicle is an unmanned sprinkler vehicle.

7. An unmanned vehicle management method comprising:
determining whether or not an unmanned vehicle can enter a traveling area on a basis of a vehicle width indicating a width of the unmanned vehicle and a track width indicating a width of the traveling area defined on a traveling path of a work site;
controlling the unmanned vehicle so as to enter the traveling area in a case where it is determined that the unmanned vehicle can enter the traveling area; and
controlling the unmanned vehicle so as not to enter the traveling area in a case where it is determined that the unmanned vehicle cannot enter the traveling area.

8. The unmanned vehicle management method according to claim 7,
wherein, in a case where it is determined that the vehicle width is narrower than the track width, it is determined that the unmanned vehicle can enter the traveling area.

9. The unmanned vehicle management method according to claim 7,
wherein, in a case where it is determined that the unmanned vehicle traveling at a first travel speed does not deviate from the traveling area on a basis of a positional deviation amount in a vehicle width direction of the unmanned vehicle traveling at the first travel speed, it is determined that the unmanned vehicle can enter the traveling area.

10. The unmanned vehicle management method according to claim 9,
wherein, in a case where it is determined that even if the unmanned vehicle traveling at the first travel deviates from the traveling area, the unmanned vehicle speed does not deviate from the traveling area when traveling at a second travel speed lower than the first travel speed, it is determined that the unmanned vehicle can enter the traveling area.

11. The unmanned vehicle management method according to claim 7,
wherein the traveling area comprises a first traveling area having a first track width and a second traveling area having a second track width narrower than the first track width, and
the unmanned vehicle comprises a first unmanned vehicle having a first vehicle width and a second unmanned vehicle having a second vehicle width narrower than the first vehicle width,
the unmanned vehicle management method further comprising:
guiding the first unmanned vehicle such that the first unmanned vehicle enters the first traveling area and does not enter the second traveling area; and
guiding the second unmanned vehicle such that the second unmanned vehicle enters each of the first traveling area and the second traveling area.
